(19) United States
(12) Patent Application Publication
(10) Pub. No.: US 2015/0158201 A1
(43) Pub. Date: Jun. 11, 2015

(54) DECORATED CONCRETE PRODUCTS

(71) Applicants: John F. Belarde, Woodinville, WA (US); Jacob J. Belarde, Snohomish, WA (US)

(72) Inventors: John F. Belarde, Woodinville, WA (US); Jacob J. Belarde, Snohomish, WA (US)

(21) Appl. No.: 14/561,001

(22) Filed: Dec. 4, 2014

Related U.S. Application Data
(60) Provisional application No. 61/913,125, filed on Dec. 6, 2013.

(51) Int. Cl. B28B 1/29

(52) U.S. Cl. CPC B28B 1/29

(57) ABSTRACT

Methods and apparatus for creating a decorative surface on concrete products are disclosed. Material used to create the decorative surface can comprise one or more of various types of decorative aggregates. The chosen aggregate pieces or particles are attached to a thin, flexible substrate by a suitable glue. The reverse or backside of the thin, flexible substrate is attached to the form face of a concrete form prior to concrete being poured. After concrete is poured in a manner careful not to dislodge the glued on aggregate, and the concrete sets, the form is removed. The glue that previously held the aggregate to the substrate is re emulsified, releasing the aggregate. This leaves the aggregate embedded in the concrete. Excess glue and any substrate particles can be removed by spraying the exposed decorative aggregate surface with a suitable reagent, such as water.

### CROSS-REFERENCE TO RELATED APPLICATION

This application claims the benefit of Provisional Patent Application No. 61/913,125, filed Dec. 6, 2013, the content of which is incorporated herein by reference.

### BACKGROUND

In many situations, it is desirable to decorate the surfaces of concrete products, for example, the surfaces of concrete blocks or walls used in a park or playground. While concrete surfaces can be painted, painting has limitations.

Disclosed is a method and apparatus for providing decorated concrete products. The products are decorated by embedding decorative aggregates, such as pieces of glass, mosaic, tiles, stone, and the like, into the surface of concrete products, in particular the vertical surface of concrete products as the products are created.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Methods and apparatus for creating a decorative surface on concrete products are disclosed. Material used to create the decorative surface can comprise one or more of various types of decorative aggregates, such as pieces or particles of glass (clear or colored), mosaic, tiles, stone, etc. The chosen aggregate pieces or particles are attached to a substrate by a suitable, preferably, water soluble, glue. Also, preferably the substrate is a thin, flexible sheet of material, such as a thin, flexible sheet of plastic or paper. The reverse or backside of the thin, flexible substrate is attached to the form face of a concrete form prior to concrete being poured. Depending on the nature of the substrate and form materials, a suitable attachment mechanism can be used to attach the flexible substrate to the form surface of the concrete form. Examples of suitable attachment mechanisms are glue and staples. After concrete is poured in a manner careful not to dislodge the glued on aggregate, and the concrete sets, the form is removed. The glue that previously held the aggregate to the substrate is re emulsified, releasing the aggregate. This leaves the aggregate embedded in the concrete.

If the glue is water soluble, a light exposure to water, i.e., a water spray, can be used to remove any residual glue or other material, such as portions of the substrate remaining attached to the aggregate, leaving an exposed decorative aggregate on the surface of the concrete. If the glue is not water-soluble, some other suitable reagent can be used to remove residual glue or other material.

The concrete can be a wall, a block, or have some other regular or irregular shape suitable for being formed by a concrete form. Thus, the concrete surface to be decorated can be flat or curved, and the decorative surface can cover either a portion of or an entire surface of the concrete product to be decorated. The concrete surfaces can be vertical, inverted, or have some other angular orientation. The concrete surface can also be a precast surface.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 is a diagram of aggregate particles or pieces glued to the surface of a substrate;

FIG. 2 is a diagram of the aggregate bearing substrate in FIG. 1 inserted into a concrete form;

FIG. 3 is a diagram of the concrete form illustrated in FIG. 2 partially filled with concrete;

FIG. 4 is a diagram of the elements of the form shown in FIGS. 2 and 3 being removed after the concrete has set; and

FIG. 5 illustrates the resultant product.

### DETAILED DESCRIPTION

As will be better understood from the following description, exemplary methods and apparatus for creating a decorative surface on concrete products are disclosed. Decorations used to create the decorative surface can comprise various types of decorative aggregates, such as pieces or particles of glass (clear or colored), mosaic, tiles, stone, etc.

The chosen aggregate pieces or particles are attached to a substrate by a suitable water soluble glue. Preferably, the substrate is a thin, flexible sheet of material, such as a thin, flexible sheet of plastic or paper.

The reverse or backside of the thin, flexible substrate is attached to the form face of a concrete form prior to concrete being poured. Depending on the nature of the form material, staples, glue, or some other suitable attachment mechanism can be used to attach the flexible substrate to the form surface of the concrete form.

After concrete is poured in a manner careful not to dislodge the glued on aggregate, and the concrete sets, the form is removed. The water soluble glue that previously held the aggregate to the substrate is re-emulsified, releasing the aggregate. This leaves the aggregate embedded in the concrete. A light exposure to water, i.e., a water spray, can be used to remove any residual glue or other material, such as a portion of the substrate remaining attached to the aggregate, leaving an exposed decorative aggregate on the surface of the concrete. The concrete can be a wall, a block, or have some other regular or irregular shape suitable for being formed by a concrete form. Thus, the concrete surface to be decorated can be flat or curved, and the decorative surface can cover either a portion of or an entire surface of the concrete product to be decorated. The concrete surfaces can be vertical, inverted, or have some other angular orientation. The concrete surface can also be a precast surface.

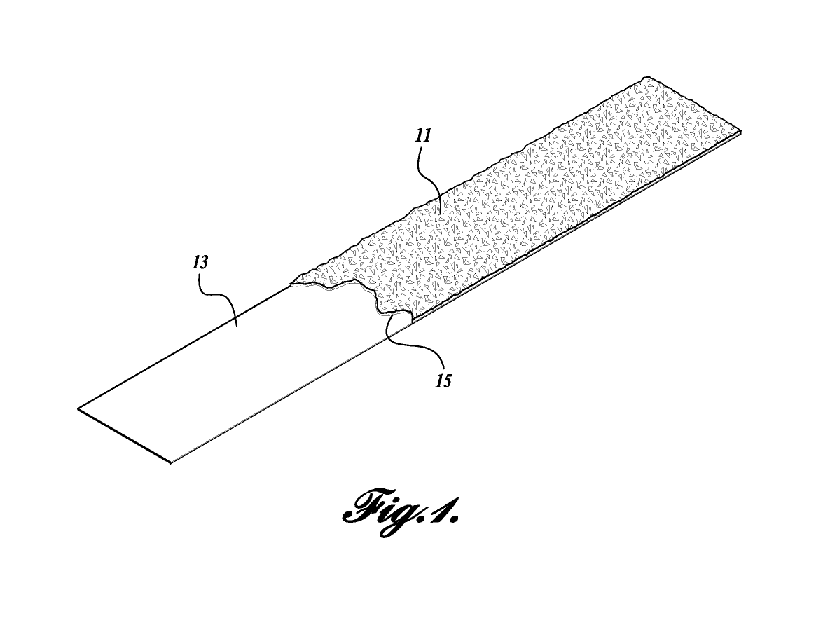

Turning to the drawings, FIG. 1 illustrates an aggregate 11 formed of a plurality of pieces or particles affixed to a substrate 13 by a water soluble glue 15. For purposes of illustration, the proportion of glue 15 is shown considerably greater than the number of aggregate particles. In a normal product, the amount of aggregate would be substantially greater than shown in FIG. 1 and the other drawings.

The substrate 13 can be formed of any suitable material, such as a thin plastic, thick paper, etc. Preferably, the chosen substrate material is flexible. As noted above, the glue 15 is, preferably, a water-soluble glue. The aggregate 11 is formed of a plurality of particles scattered over the substrate. As also noted above, the aggregate particles are attached or affixed to the substrate 13 by the glue 15. A variety of aggregate particles can be utilized including, but not limited to, glass particles (clear or colored), pieces of a mosaic, pieces of tile, pieces of stone, etc. The aggregate particles may all be of the same type or different. The aggregate particles may be randomly distributed or distributed in a predetermined manner, including a manner that creates a desired image.

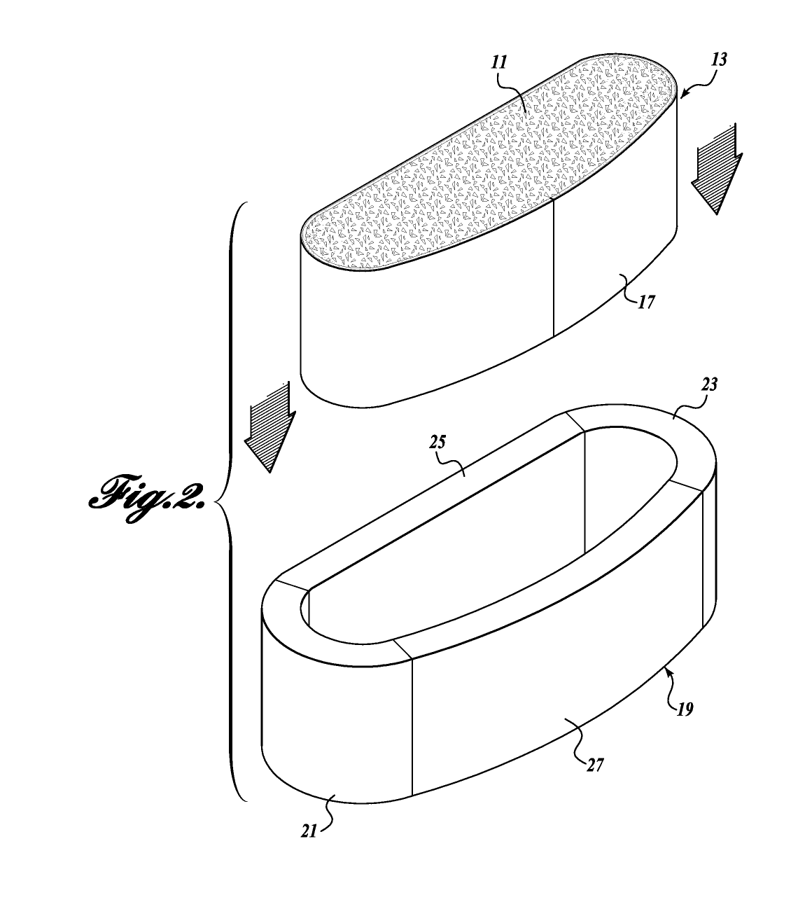

As shown in FIG. 2, the backside 17 of the substrate 13, i.e., the side opposite the side to which the aggregate 11 is glued, is positioned on the form-defining surface or surfaces of a concrete form 19. For purposes of illustration only, the form 19 is shown as comprising four interconnected pieces, two end pieces 21 and 23 and two side pieces 25 and 27, all of which have vertical surfaces. The pieces are interconnected or joined together in any suitable manner well known in the concrete forming art. The inner or form surfaces of the four pieces are vertical oriented and to some degree curved rather than planar. The backside or non-aggregate surface 17 of the substrate 13 is positioned on the inner or facing surfaces of the form pieces 21, 23, 25, and 27. The inner or facing surfaces are the product shape defining surfaces of the form 19. Depending upon the material used to create the form pieces 21, 23, 25, and 27, the substrate 13 may be attached by staples, glue, or some other suitable attachment mechanism. In some instances physical or mechanical attachment may not be necessary.

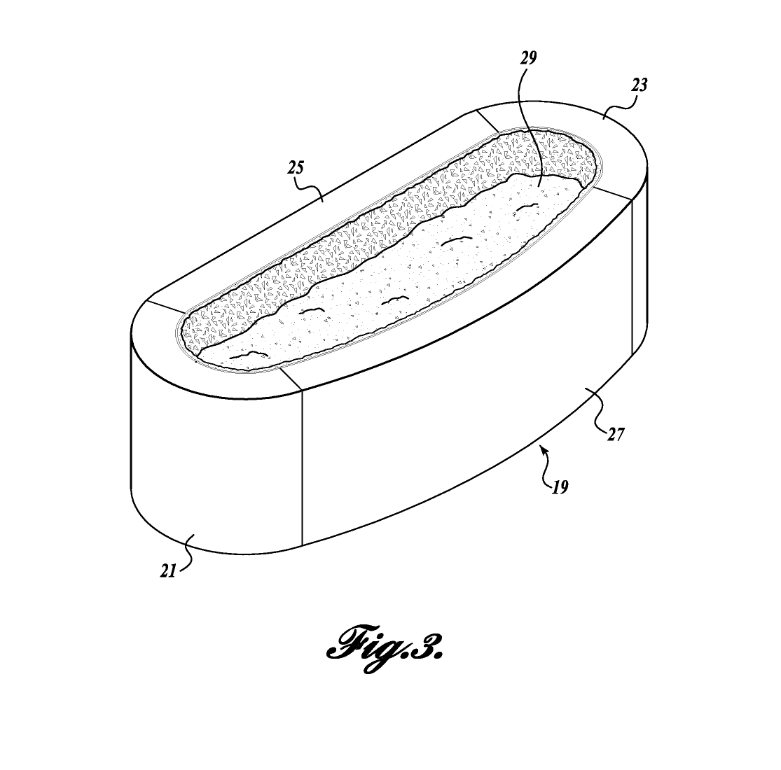

After the substrate 13 is attached to the joined elements of the form 19, i.e., the pieces 21, 23, 25, and 27, concrete is carefully poured into the form 19 so as not to dislodge the aggregate 11. FIG. 3 illustrates concrete 29 partially filling the form 19.

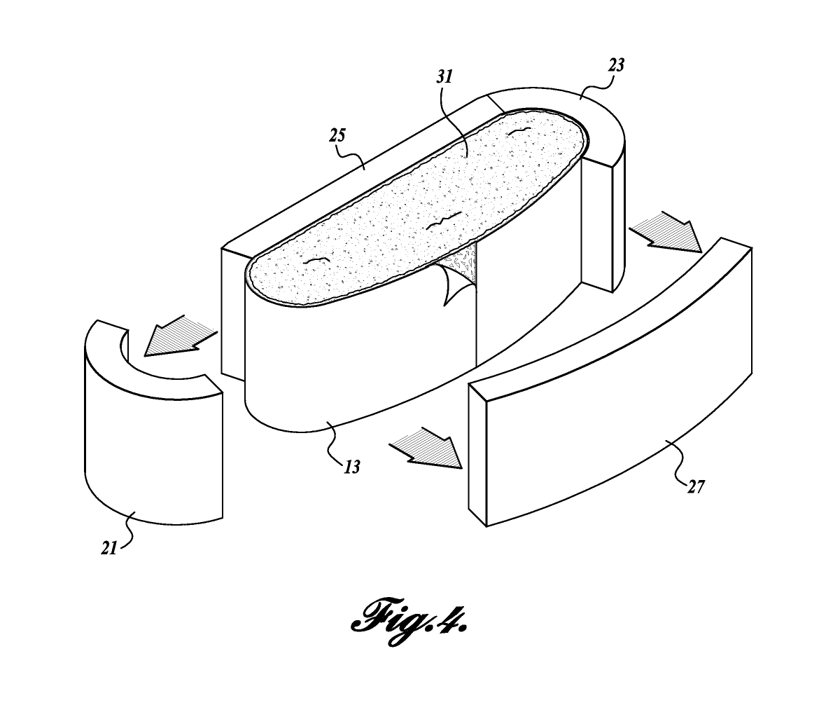

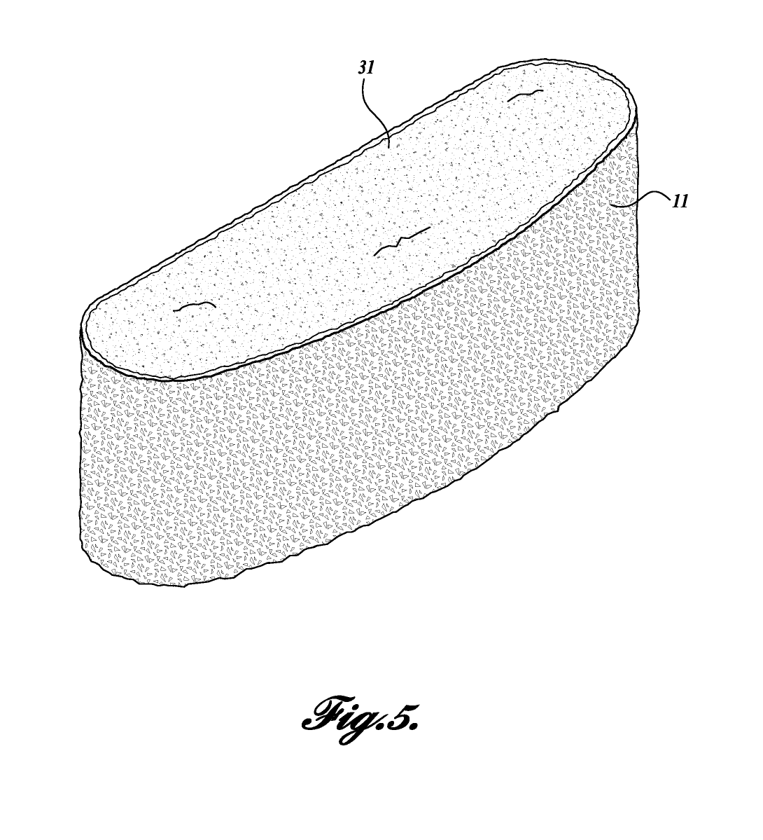

After the concrete form 19 is full of concrete and the concrete has set, as shown in FIG. 4, the various pieces 21, 23, 25, and 27 of the form are removed in a conventional manner. Thereafter, any portion of the substrate 13 remaining attached to the now cured concrete 31 is removed. Any residual glue or portions of the substrate remaining attached to the concrete block or the aggregate can be removed using water, which re-emulsifies the water-soluble glue used to attach the aggregate 11 to the substrate 13. If a glue, other than a water-soluble glue, is used, a suitable reagent rather than water may be used, alcohol or gasoline, for example. The end result is the concrete block depicted in FIG. 5 having aggregate attached to the vertical surface of the block.

While, for purposes of illustration, the block is shown as curved, obviously, the block could be a rectangular parallelepiped with one or more surfaces decorated with an aggregate. Also, the block could take the form of a wall, such as a retaining wall, with the exposed surface or surfaces of the wall decorated with a suitable aggregate. In addition to being vertical, the concrete surface to be decorated can be inverted or have some other orientation. In addition, the decorative surface can be applied to a precast concrete product. Further, rather than covering the entire form-defining surface of the form, the aggregate may be applied to only a portion or portions of the form-defining surface or surfaces of the form. As a result, as will be readily appreciated by those skilled in the art and others, the methods and apparatus as described herein can be used in a variety of environments to create a variety of different types of decorated concrete products.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of creating a decorated concrete product comprising:
applying an aggregate to a layer of glue located on one surface of a substrate;
positioning the substrate on the form-defining surface (“form face”) of a concrete form such that the aggregate faces the concrete-receiving region of the form;
pouring concrete into the concrete form;
after the poured concrete has set, separating the form and the concrete; and
if necessary, removing any portion of the glue and the substrate attached to the resulting decorated concrete product.

2. The method of creating a concrete product as claimed in claim 1, wherein the glue is a water-soluble glue, and wherein any portion of the glue and the substrate attached to the resulting decorated concrete product is removed by spraying the decorated surface of the decorated concrete product with water.

3. The method of creating a decorated concrete product as claimed in claim 1, wherein the substrate is a sheet of material.

4. The method of creating a decorated concrete product as claimed in claim 3, wherein the sheet of material is thin.

5. The method of creating a decorated concrete product as claimed in claim 4, wherein the sheet of thin material is chosen from the group consisting of thin plastic and thick paper.

6. The method of creating a decorated concrete product as claimed in claim 1, wherein the substrate is attached to the form face of the concrete form.

7. The method of creating a decorated concrete product as claimed in claim 6, wherein the substrate is attached to the form face of the concrete form by an attachment mechanism chosen from the group consisting of glue and staples.

8. The method of creating a decorated concrete product as claimed in claim 1, wherein the aggregate is chosen from the group consisting of glass particles (clear or colored), pieces of mosaic, pieces of tile, and pieces of stone.

9. Apparatus for creating a decorative concrete product comprising:
a concrete form, the concrete form including a face that defines an area of a product to be created by the form when concrete is poured into the form that is to be decorated with an aggregate;
a substrate positioned on the face that defines the area of a product to be created by the form when concrete is poured into the form that is to be decorated with an aggregate; and
an aggregate glued to the substrate so as to face the area of a product to be created by the form when concrete is poured into the form that is to be decorated with an aggregate.

10. Apparatus for creating a decorative concrete product as claimed in claim 9, wherein the glue is a water-soluble glue.

11. Apparatus for creating a decorative concrete product as claimed in claim 9, wherein the substrate is a sheet of material.

12. Apparatus for creating a decorative concrete product as claimed in claim 11, wherein the sheet of material is thin.

13. Apparatus for creating a decorative concrete product as claimed in claim 11, wherein the sheet of thin material is chosen from the group consisting of thin plastic and thin paper.

14. Apparatus for creating a decorative concrete product as claimed in claim 9, wherein the substrate is attached to the face of the form that defines an area of a product to be created by the form when concrete is poured into the form that is to be decorated with the aggregate.

15. Apparatus for creating a decorative concrete product as claimed in claim 14, wherein the substrate is attached by an attachment mechanism.

16. Apparatus for creating a decorative concrete product as claimed in claim 15, wherein the attachment mechanism is chosen from the group consisting of glue and staples.

17. Apparatus for creating a decorative concrete product as claimed in claim 9, wherein the aggregate is chosen from the group consisting of glass particles (clear or colored), pieces of a mosaic, pieces of tile, and pieces of stone.

18. A decorated concrete product produced in accordance with the method recited in claim 1.

19. The decorated concrete product claimed in claim 18, wherein the aggregate is chosen from the group comprising glass particles (clear or colored), pieces of mosaic, pieces of tile, and pieces of stone.
